(19) United States
(12) Patent Application Publication
(10) Pub. No.: US 2007/0134360 A1
(43) Pub. Date: Jun. 14, 2007

(54) Device for the Production of Molded Parts and Structural Unit for Use in Such a Device

(76) Inventors: Roland Schmelcher, Neuenstadt (DE); Armin Klotzbucher, Gundelsheim (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/551,947

(22) Filed: Oct. 23, 2006

Related U.S. Application Data
(63) Continuation of application No. PCT/DE05/00581, filed on Apr. 1, 2005.

(30) Foreign Application Priority Data
Apr. 22, 2004 (DE) 10 2004 019 633.8

(51) Int. Cl. B29C 33/00

(52) U.S. Cl. 425/182; 425/190; 425/193

(57) ABSTRACT

A device for the production of molded parts which includes a core carrier frame 11, and a core assembly which includes a core part 31 having a die surface 33, and an ejector plate 41 associated with the core part to form a structural unit which can be easily assembled onto and removed from the carrier frame 11. The structural unit which includes the core part 31 and the ejector plate 41 can thus be assembled to and removed from the frame 11 as an integral unit, which enables a simple and rapid equipping of the molded device for the production of a variety of products. A jacket die 51 overlies the die surface 33 of the core part 31 to form a die cavity therebetween.

### CROSS REFERENCE TO RELATED APPLICATION

The present application is a continuation of international application PCT/DE2005/000581, filed 1 Apr., 2005, and which designates the U.S. The disclosure of the referenced application is incorporated herein by reference.

### BACKGROUND OF THE INVENTION

The present invention is directed to a device for the production of molded parts, especially those formed by injection molding, die-casting or press forming with a core part. The device includes an ejection device associated with a core part, a core carrier for carrying the core part, and a die. The core part and the die can be braced in relation to one another, thus forming a cavity corresponding to the molded part. The invention further relates to a specific structural unit consisting of a core part and an ejection device for use in the inventive device.

Such devices are particularly suited for producing parts for vehicles such as crash beams, large-area paneling, dashboards, spoilers and the like.

Devices of this general category are well known in practice. Reference to this will only be made to EP 1 30 399 A1 or to DE 100 8 894 A1 for the purpose of examples.

A device of this general type typically includes a core part featuring a profile-generating core surface and a jacket component with a profile-generating jacket surface, which can be braced against one another between a machine-side mounting area and an pressure-exerting allocation, thus confining a cavity, which corresponds to the molded part to be made and, in the case of formation as a injection molding tool, creates an opening in said cavity for the high-pressure feed of injection casting material. The core part and the jacket part are also typically referred to as dies.

The bottom of the core part is connected with a special molding part via actuator rods and/or via guide elements and as such, connected with the ejection device associated with the special core part. This device can be moved between an operating position and an eject position relative to the core part. By moving the ejection device into the eject position, the sliding ejection inserts, which are inserted in the profile-generating core surface of the core part in a form-fitting manner while the unit is in the operating position, are extended, thus effecting an ejecting motion for the demolding of the molded part.

The core part can be mounted on a core carrier, which is designed in a plate-like shape and which exhibits several holes, which are penetrated by the aforementioned actuator rods and/or guide elements in order to enable the eject motion of the ejection device relative to the core part. The modular construction comprised of the core part and the separate core carrier presents the advantage that various core parts with a different profile-generating core surfaces can be mounted on the same core carrier as seen fit in order to produce a variety of molded parts. The associated jacket part is also to be replaced here. However, the implementation of various core parts consumes a large number of resources in terms of setting it up since not only the core part mounted on the top of the core carrier, but also the ejection device assigned to the bottom together with the respective core part must be replaced. This requires, particularly with respect to the actuation mechanism of the laterally-actuated ejection sections of the core part such as the actuation mechanism of the corner slides, a considerable amount of resources.

The invention in question is therefore based on the task of building on and further developing the device of this classification in a manner that enables problem-free rapid equipping for the various molded parts with a basic construction of the device.

### SUMMARY OF THE INVENTION

The above and other objects and advantages of the invention are achieved in that the core carrier is embodied as a core carrier frame comprising a passage and that the core part together with the ejection device form a structural unit that can be inserted on one side into the core carrier frame and that the ejection device extends through the passage when inserted into the frame.

In the case of the inventive device, the core carrier is designed in the shape of a frame together with a central passage enabling the ejection device to pass through. As a result, the core part and the ejection device, for example in the form of an ejector plate, can be mounted on the core carrier frame as a pre-assembled structural unit, especially from above, along a single mounting direction, by means of inserting this unit on one side. Thus, the core part together with the ejector plate in front can be attached to or inserted into the core carrier frame. The passage of the core carrier frame for this is dimensioned such that the ejector plate can be passed through said passage. Also in the case of disassembly, the core part and the ejector plate can be removed from the core carrier frame as a collective structural unit in the direction opposite to the one in which it was assembled.

The core part designated for a special molded part and the ejector plate associated with this core part can therefore stay connected with one another while they are being mounted on the core carrier or while being removed from the core carrier. Furthermore, it is not necessary, as with known core carriers that feature a continuous base, to separate the connection between the core part and the associated ejector plate in order to mount the core part on the one side, especially from above, on the core carrier and secure the ejector plate from the opposing side, particularly from below, on the core carrier.

The fact that the core part and the ejector plate can be inserted or removed, preferably by the simple pulling-out of the unit, from the core carrier frame as a collective structure unit enables a simple and rapid equipping of the tool for generating various molded parts. Trials have demonstrated that the structural unit comprised of the core part and the ejector plate in an assembled state can be removed in approximately one hour without having to be further disassembled for this purpose. At the same time, the same process with the known construction takes up to 20 hours or more. The core carrier frame can therefore be outfitted with entirely different core parts in a relatively limited amount of time such that, if the associated jacket part is also replaced in a corresponding manner, virtually any multitude of various types of molded parts such as crash beams can be produced with the same core carrier frame. As such, the core carrier frame is equally suited for the assumption of prototype inserts and series core parts each in connection with the associated jacket part.

Depending on which height of the core carrier frame the core part is mounted on, the ejector plate connected with the core part passes into or sticks out of the central passage of the core carrier frame during assembly. In any case, the passage surrounds the actuator rods and any guide elements, which connect the ejector plate in the operating position with the core part. It is therefore important that the core carrier frame features only a single central passage essentially for all mounting rods and guide elements between the core part and the ejector plate such that none or at worst, few connections between the core part and the ejector plate have to be disconnected in order to mount the core part with the ejector plate on the core carrier frame or in order to remove said structural unit from the core carrier frame. In addition to the central passage, the core carrier frame may, as is often the case, feature additional holes (with or without threading) or channels for the purposes of assembly, guidance, cooling or for the power supply without this affecting advantages achieved by the inventive core carrier frame in a detrimental way.

It is preferred that the core part passes, at least partially, form-fitting into the central passage of the core carrier frame when the device is in an assembled state. This ensures that the core part has a more secure lateral position on the core carrier frame.

The core part preferably features lateral support members, which rest on top of the core carrier frame when the device is in an assembled state, and they are positioned there such that the core part is securely mounted on the core carrier frame.

It is further preferred that the core carrier frame features the basic form of a closed ring with a right-angled or rectangular outline. This enables the core carrier frame to be outfitted with various core parts in a particularly flexible manner.

It is further preferred that the core carrier frame is mounted to a base plate, which allows for the device to be secured to a machine-side mounting area. A modular construction featuring a core carrier frame and a separate base plate simplifies the production of these components. Only a replacement of the core part together with the ejector plate and the jacket part is necessary, as previously described, in order to enable the outfitting of the tool with various molded parts. The flexible core carrier frame that can be outfitted, however, can remain on the base plate on a permanent basis. As an alternative to the modular construction explained, the core carrier frame and the base plate may also be designed as single pieces.

It is also preferred that a liftable adapter plate is supported on said base plate (separately or integrated with the core carrier frame). Said adapter plate can be securely connected with the ejector plate in order to initiate the ejecting motion of the ejector plate. As such, the adapter plate also helps to adjust the tool in a flexible manner for the production of various molded parts. For the assembly of a core part corresponding to a certain molded part, it is therefore only necessary to guide the ejector plate, connected to the core part to form one structural unit, through the passage in the core carrier frame and to permanently connect it to the adapter plate.

In terms of the structural unit comprised of the core part and the ejection device, the fundamental task of the invention in question is to provide a corresponding structural unit, which enables problem free rapid equipping of a corresponding device, particularly of an inventive device, for various molded parts with simple construction of the structural unit.

This task is solved by means of a structural unit for a device for the production of molded parts, particularly injection molding, die-casting or press forming, and with the structural unit constituting a core part and an associated ejection device, whereupon the core part and the ejection device are carried by a core carrier and the core part and a jacket part, which is not part of the structural unit, can be braced in relation to one another such that they form a cavity corresponding to the molded part. The structural unit is characterized in that the core carrier is embodied to be a core carrier frame with a passage and that the structural unit has been inserted in the core carrier frame on one side and that the ejection device extends through the passage in the inserted state.

Also with reference to the inventive structural unit that can be handled, which itself is independent of the inventive device, it is important that an ejection device is associated with the core part such that the structural unit can be completely inserted in a corresponding device or removed from said device, that is by means of a core carrier frame designated for this device.

### BRIEF DESCRIPTION OF THE DRAWINGS

There are now various possibilities to design and further develop the innovative approach of this invention in an advantageous manner. For this, reference is to be made to the following description of a preferred exemplary embodiment of the invention, which refers to the schematic drawings, in which:

FIG. 1 is a perspective view of a core carrier frame of the invention,

FIG. 1a is a perspective view of the core carrier frame, showing just its basic structure,

FIG. 2 is a perspective view of the base plate of the invention,

FIG. 2a is a perspective view showing the basic structure of the base plate,

FIG. 3 is a perspective view of the core carrier frame as per FIG. 1 mounted on the base plate as per FIG. 2,

FIG. 4 is a perspective view of a core part with an ejector plate inserted in the core carrier frame,

FIG. 5 is a perspective view of the core part inserted in the core carrier frame together with the ejector plate, arranged on the base plate with the adapter plate designated for the intermediate position,

FIG. 5a is a perspective view of the structural components from FIG. 5, showing just its basic structure,

FIG. 6 is a perspective view of the core part in a non-installed state,

FIG. 7 is a perspective view of the ejector plate on an ejector adapter plate,

FIG. 8 is a perspective view of the jacket die of the invention mounted in a carrier,

FIG. 8a is a perspective view of the jacket die, showing just its basic structure,

FIG. 9 is a perspective view of the jacket die in a non-installed state,

FIG. 10 is a perspective view of the jacket die carrier,

FIG. 11 is a perspective view of a bracing plate for bracing the jacket die carrier,

FIG. 12 is a longitudinal sectional view of the basic parts of the entire device of the invention, and

FIG. 13 is a transverse sectional view of the basic parts of the entire device of the invention.

### DETAILED DESCRIPTION OF THE PREFERRED EMBODIMENT

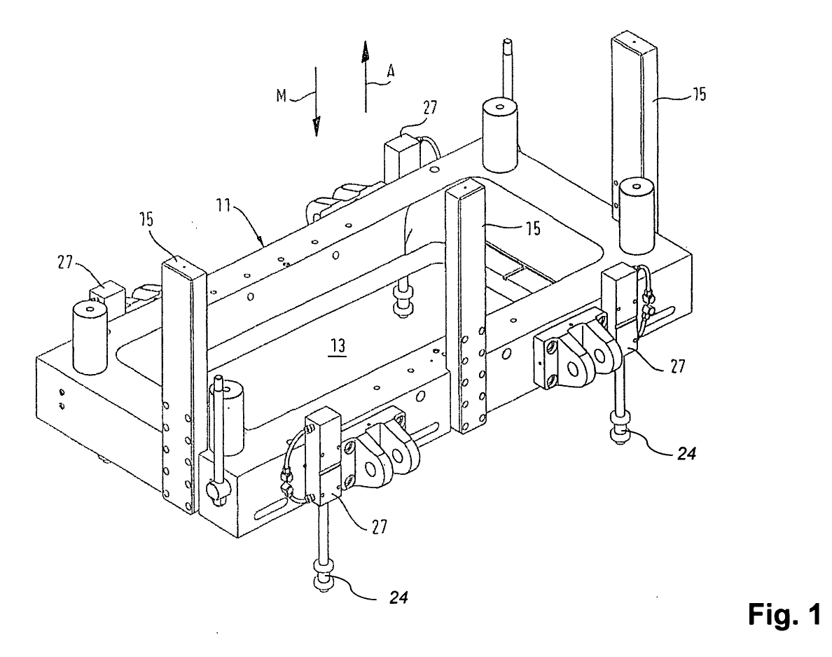

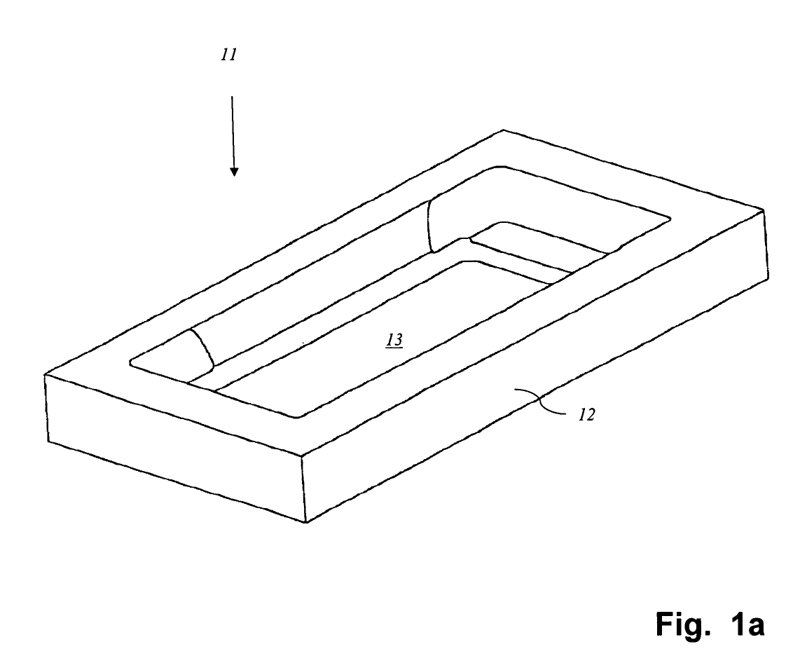

FIG. 1 shows a core carrier frame 11, which is a component of an injection molding machine and serves to support a core part 31. The core carrier frame 11 essentially exhibits the form of a frame with a rectangular cross section, which essentially defines a rectangular central passage 13. The core carrier frame 11 has various transport, guide and mounting devices attached thereto, which are known in connection with conventional core carriers. For example, the vertical guide bars 15 have been shown, which serve to guide the jacket die to be subsequently discussed.

Furthermore, FIG. 1 shows the total of four lifting devices 27 allocated along the core carrier frame 11, which serve to lift and lower a liftable adapter plate 25 which is not shown in FIG. 1.

FIG. 1a shows the frame from FIG. 1 reduced to the basic features. In this way, FIG. 1a shows the core carrier embodied as a core carrier frame 11, which serves to carry the core part 31 together with the ejection plate 41 as described below. FIG. 1a clearly shows that the core carrier is embodied in a frame-like manner and that it features a central passage 13. The four legs 12 of the core carrier frame 11 are disposed in a rectangular arrangement.

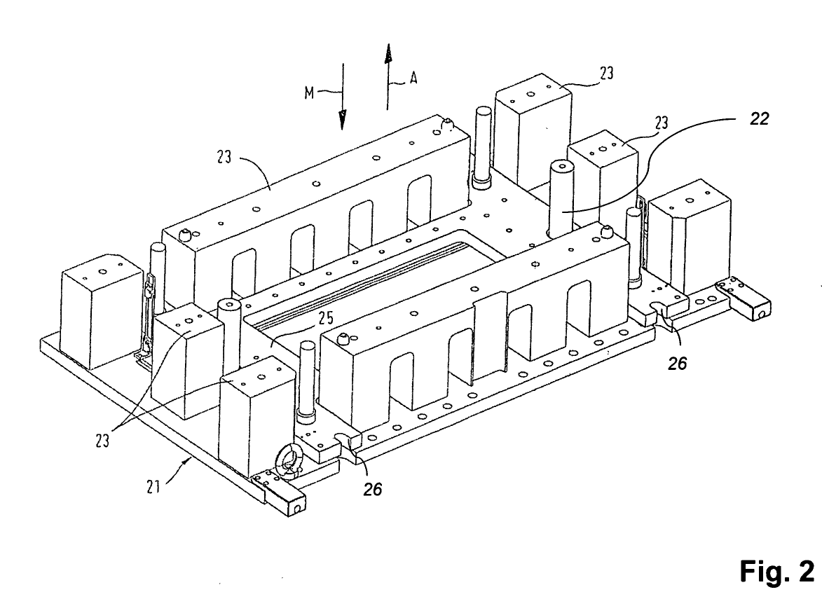

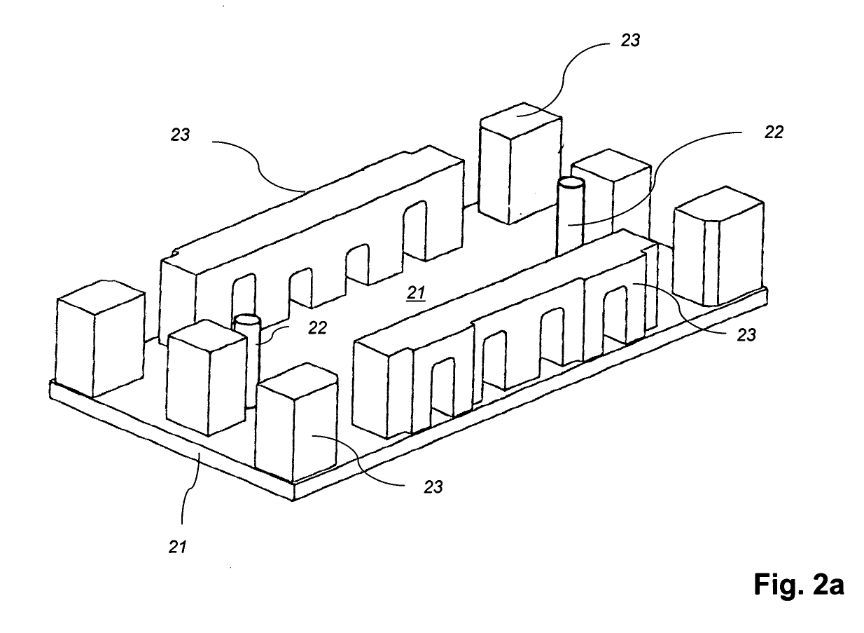

FIG. 2 depicts a base plate 21, also referred to as a clamping plate, with several support posts 23 extending upwardly from the plate 21. The support posts 23 serve to support the core carrier frame 11 at a predetermined separation from the base plate 21. An adapter plate 25 that can be lifted vertically is positioned on the base plate 21. The lifting devices 27 shown in FIG. 1 serve to vertically lift the adapter plate 25. These lifting devices 27 reach into the carrying slots 26 and include special lifting elements 24 on each side of the slot.

FIG. 2a shows the base plate from FIG. 2 in a schematic view, reduced however to its basic features. In such a way, FIG. 2a shows the base plate 21 without the adapter plate 25, but with the support posts 23, which are embodied as separation bodies extending orthogonally from the base plate 21. Furthermore, FIG. 2a depicts guide pins 22, which serve to guide the upward movement of the adapter plate 25.

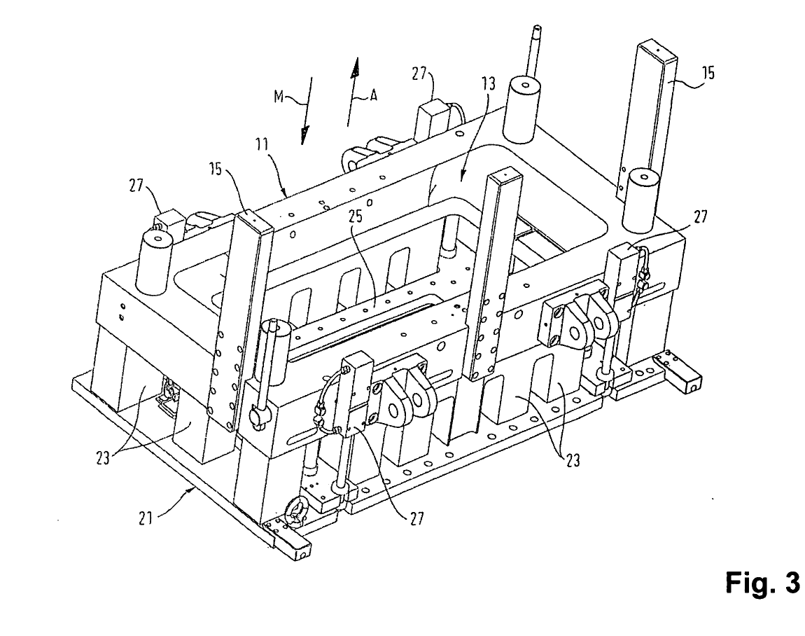

When the tool is in the assembled state, the core carrier frame 11 shown in FIGS. 1 and 1a is permanently mounted to the top of the support posts 23 of the base plate 21 as shown in FIG. 2. This state is shown in FIG. 3. From FIG. 3, the four lifting devices 27 mounted on the outside of the core carrier frame 11 are especially visible, by means of which the adapter plate 25 can be lifted vertically along an ejection route A.

Furthermore, FIG. 3 clearly shows that the core carrier frame 11 rests on or against the support posts 23, whereupon the actuating mechanism actuates the adapter plate 25 between the base plate 21 and the core carrier frame 11.

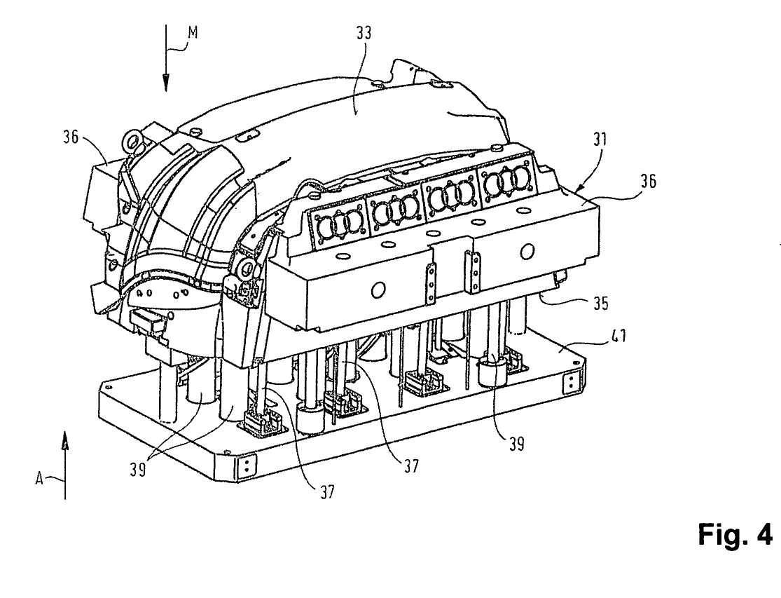

FIG. 4 depicts a core assembly which includes a core part 31 with a profile-generating upper die surface 33 and an essentially flat bottom 35. Around the profile-generating die surface 33, the core part 31 features laterally positioned support members 36, which serve to rest or bear upon the core carrier frame 11. The bottom 35 of the core part 31 is connected via several actuator rods 37 and guide columns 39 with an essentially rectangular ejector plate 41. The core part 31 and the ejection plate 41 embody the structural unit that has already been mentioned several times, which can be inserted in the core carrier frame 11 as a whole and which can also be removed again in a corresponding manner.

The ejector plate 41 is shown in its operating position in the diagram from FIG. 4, in which ejector inserts have been integrated form-fit into the profile-generating surface 33 of the core part 31. Based on this operating position, the ejector plate 41 can be driven along the ejector route A relative to the core part 31 into an eject position, whereupon the ejector plate 41 is driven by the guide columns 39. Based on such an ejecting motion, the aforementioned ejector inserts are driven upwards out of the core part 31 by means of the actuator rods 37 and/or actuated laterally in order to demold a molded part that has been produced.

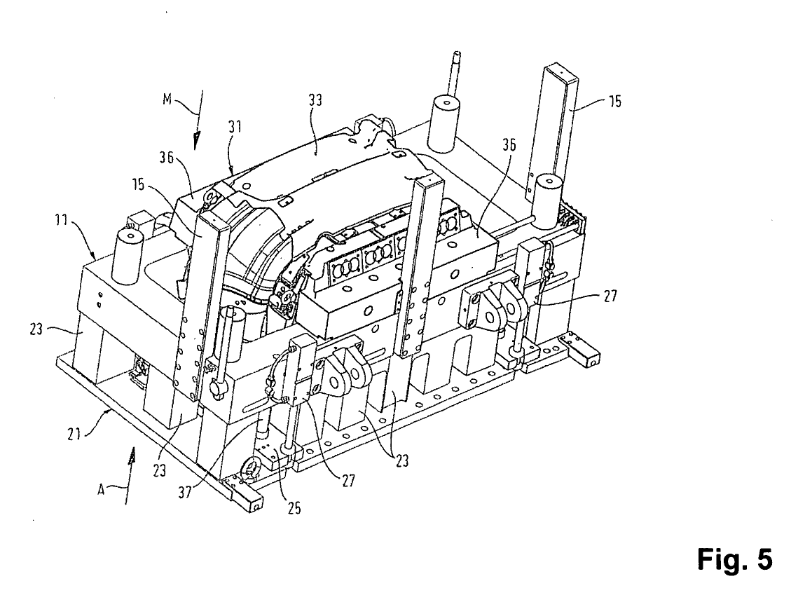

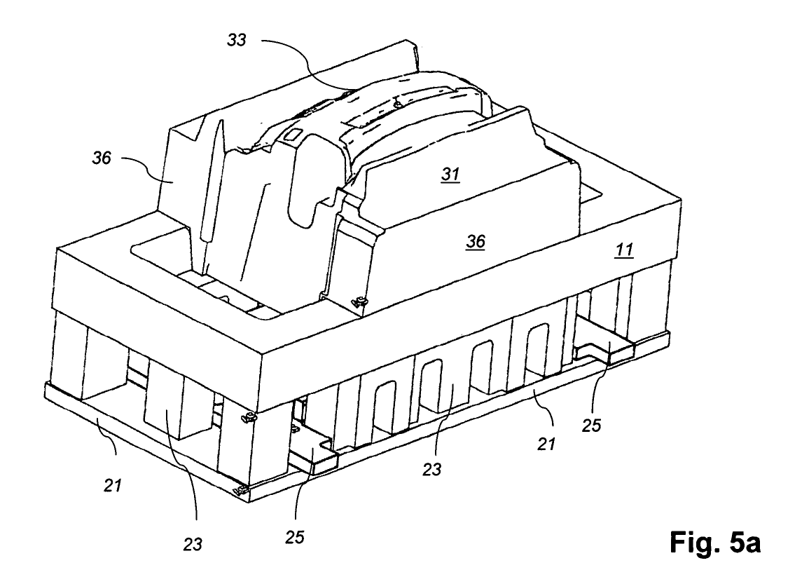

FIG. 5 shows a complete core assembly with the base plate 21 and with the core carrier frame 11 mounted on its upper side. The core part 31 has been inserted in the core carrier frame 11. The ejector plate 41 connected with the core part 31 on the bottom side reaches to be closely adjacent the base plate 21, namely in the passage between the support posts 23.

FIG. 5a shows the structure from FIG. 5, reduced however only to the basic structural features. In such a way, FIG. 5a depicts the core part 31, which rests on or against the core carrier frame 11 by means of its support members 36. In addition, the core part 31 extends in a more or less form-fit relationship into the core carrier frame 11.

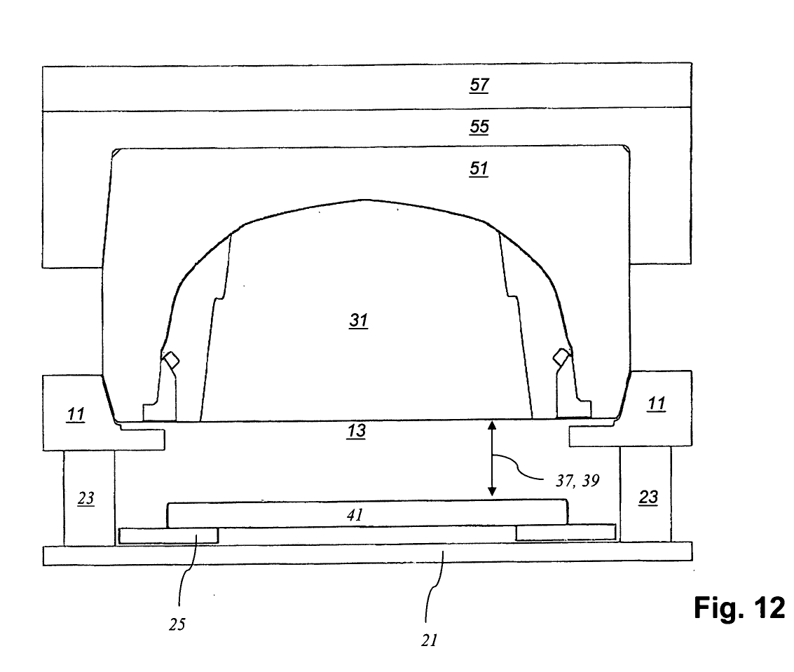

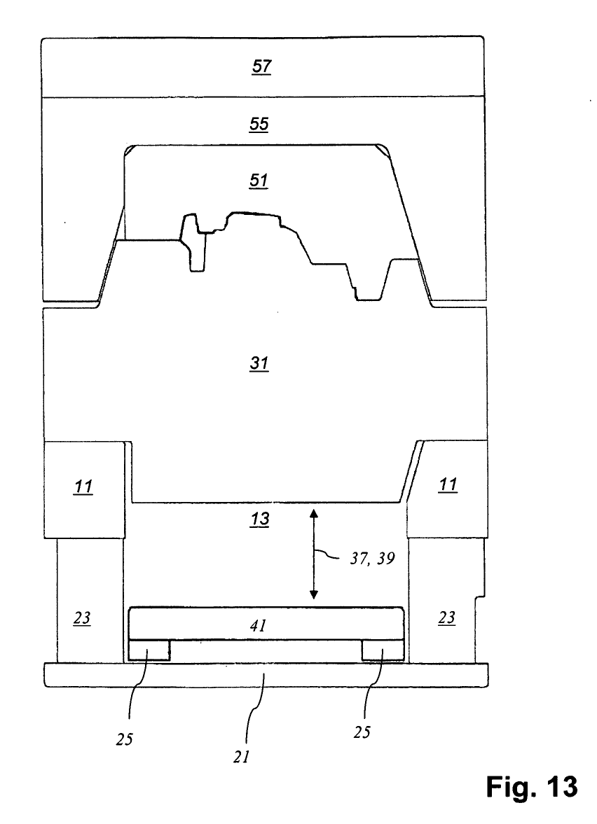

FIG. 5a further depicts that the core carrier frame 11 rests on the support posts 23, whereupon the support posts 23 extend down to the base plate 21 orthogonally. The adapter plate 25 is positioned between the ejector plate 41 and the base plate 21, note FIGS. 12-13.

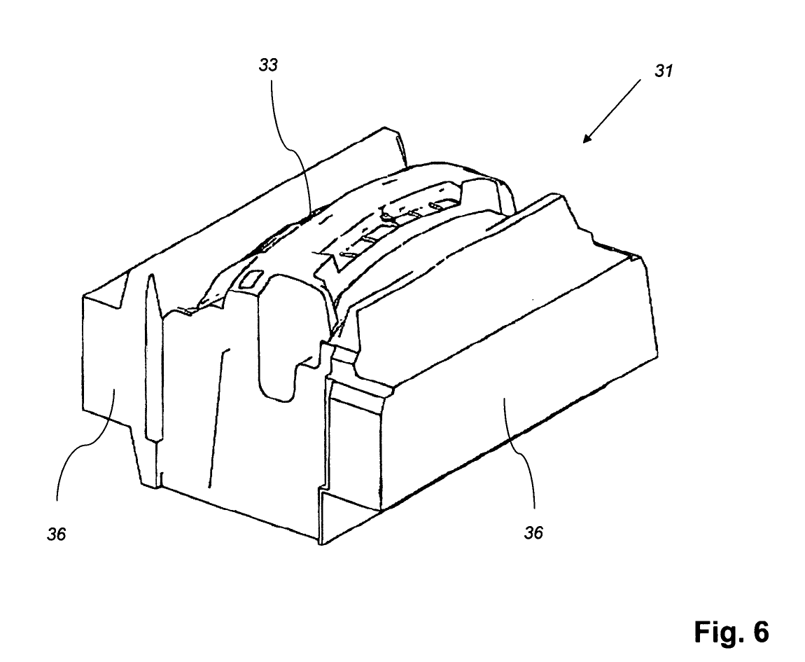

FIG. 6 shows the core part 31 in an uninstalled state in a schematic view, whereupon the core part 31 features the support members 36 that serve to rest upon the core carrier frame 11 as assembled components.

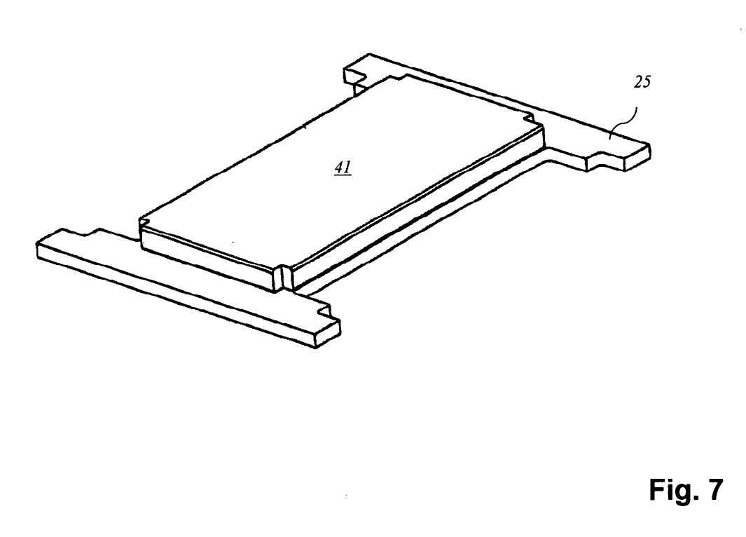

FIG. 7 depicts the adapter plate 25 in a schematic view, which is allocated between the base plate 21 and the core carrier frame 11 in a liftable position as per the diagram in FIGS. 5 and 5a. The ejector plate 41 may thus be lifted upon a lifting motion of the adapter plate 25, and thus the actuator rods 37 and the guide columns 39 can be moved against the core part 31, that is, in order to carry out the ejection step.

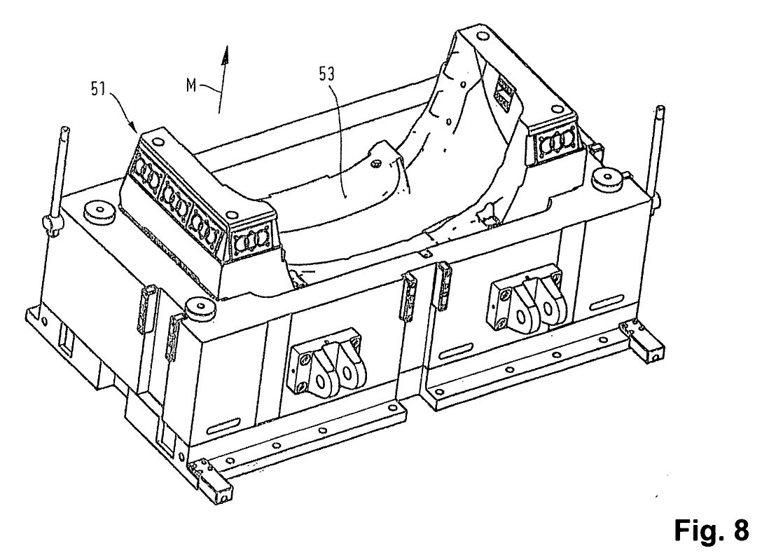

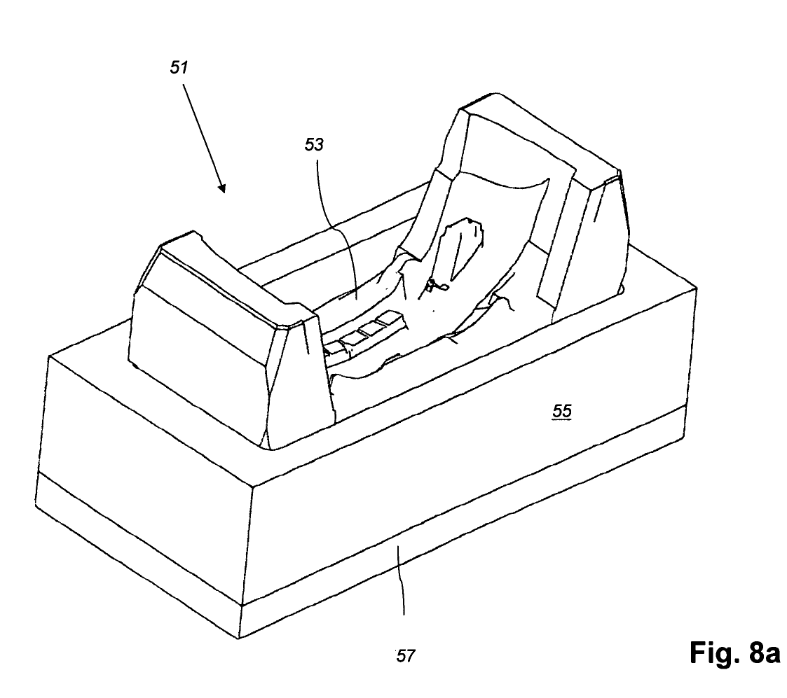

FIG. 8 shows, upside down to facilitate recognition, a jacket die 51 assigned to the core part 31, which is typically also referred to as a die, and, on its lower side (upper side shown in the diagram as per FIG. 8) a profile-generating jacket surface 53.

The core carrier frame 11, the base plate 21 with the adapter plate 25, the core part 31 with the ejector plate 41 and the die jacket 51 embody a device for producing injection molded parts, for example, plastic crash beams for vehicles. In the assembled state, the profile-generating die surface 33 of the core part 31 and the profile-generating jacket surface 53 of the jacket die 51 define a cavity corresponding to the crash beam or other product to be produced. In said cavity, there is at least one opening for the high-pressure injection of the injection molding material (not shown in the figures). The core construction as per FIG. 5 and the jacket die 51 as per FIG. 8 can, for this purpose, be braced against one another between a machine-side mounting area and a pressure-exerting allocation.

FIG. 8a depicts the structure from FIG. 8, reduced however to the basic features. In this way, FIG. 8a facilitates the recognition of the jacket die 51 with the profile-generating jacket surface 53. The jacket surface 53 is supported in a die carrier 55, which in turn rests against a bracing plate 57.

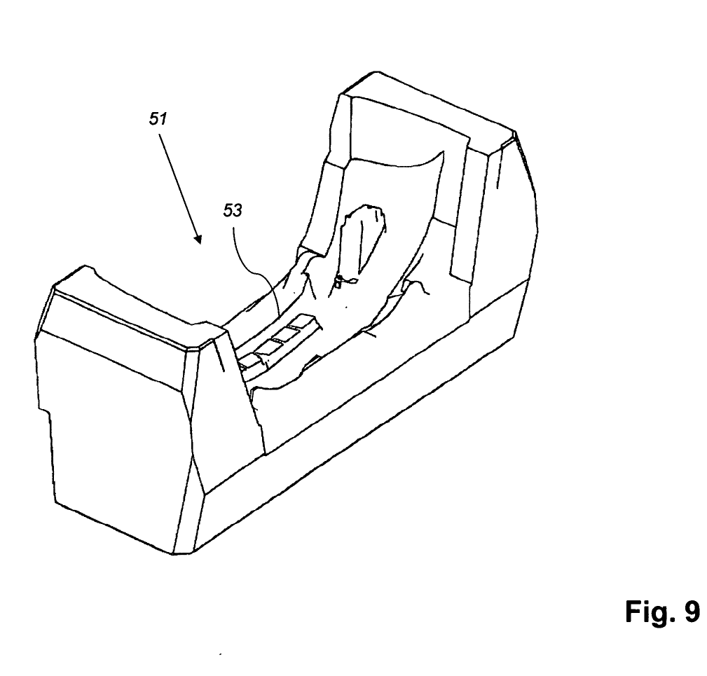

FIG. 9 shows the jacket die 51 in an uninstalled state in a schematic view, whereupon the profile-generating jacket surface 53 is illustrated.

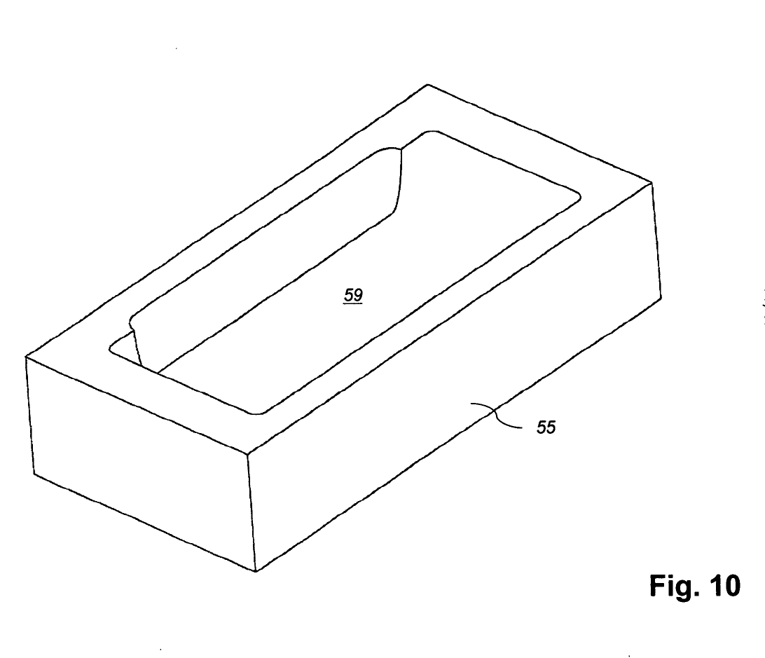

FIG. 10 shows the die carrier 55 in an unloaded state. The recess 59 seen in this diagram serves to carry the jacket die 51.

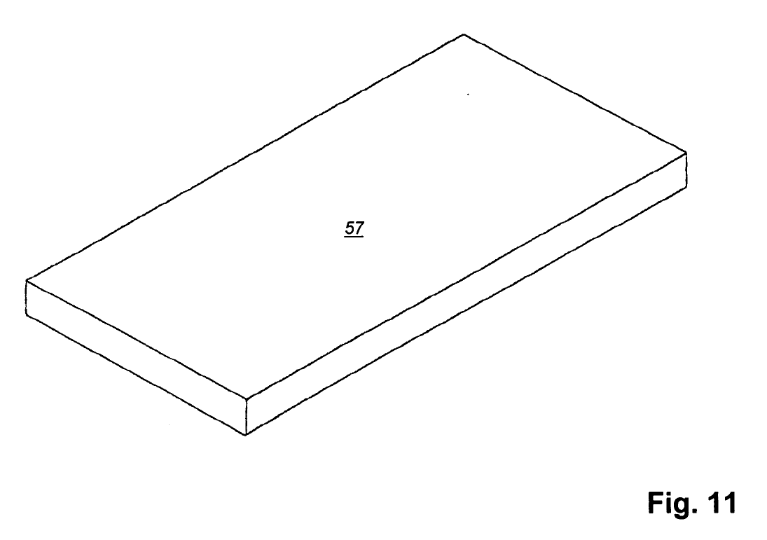

FIG. 11 shows the bracing plate 57 for the die carrier 55.

The unique feature of the device shown in the figures lies in the design of the core carrier frame 11 with the central passage 13 and in the consequently highly-simplified mounting and removal of the core part 31 from the core carrier frame 11. The core construction shown in FIGS. 5 and 5a can in fact be mounted or replaced in the following simple fashion:

The core carrier frame 11 is permanently secured, as shown in FIG. 3, to the upper portion of the support posts 23 of the base plate 21, whereupon the adapter plate 25 located between the support posts 23 is carried by the lifting devices 27 of the core carrier frame 11 in a vertically extendable position. The base plate 21 with the adapter plate 25 and the core carrier frame 11 can be implemented universally for various molded parts.

The core part 31 and the ejector plate 41 are specially designed for a certain molded part to be produced. The core part 31 and the ejector plate 41 together with the associated actuator rods 37 and guide columns 39 are pre-assembled to embody a collective structural unit as shown in FIG. 4.

The pre-assembled structural unit comprised of core part 31 and ejector plate 41 as per FIG. 4 is inserted from above along a vertical, mounting route M that is facing down into the unit comprised of the base plate 21 and the core carrier frame 11 mounted to it as per FIG. 3. In this process, the ejector plate 41 pointed into the mounting route M is first inserted into the central passage 13 of the core carrier frame 11. While the core part 31 is moved further along the mounting route M, the ejector plate 41 passes through the central passage 13 of the core carrier frame 11. Finally, as shown in FIG. 5, the core part 31 will rest on top of the core carrier frame 11 via the lateral support members 36, whereupon the lower flat bottom 35 of the core part 31 extends into the central passage 13 of the core carrier frame 11. In the process, the ejector plate 41 located in the operating position will rest on top of the adapter plate 25, note FIGS. 12-13.

The core part 31 is now attached to the core carrier frame 11, for example by means of bolt connections. Likewise, the ejector plate 41 and the adapter plate 25 are connected with one another.

The disassembly of the core part 31 from the core carrier frame 11 occurs in reverse order. First, the connections between the core part 31 and the core carrier frame 11 as well as between the ejector plate 41 and the adapter plate 25 are unfastened. Afterwards, the structural unit can be removed from the core part 31 and the ejector plate 41 connected with said core part 31 backwards along the mounting route M and out of the core carrier frame 11, whereupon the ejector plate 41 in turn passes through the central passage 13 of the core carrier frame 11.

The mounting and removal of the core part 31 with the ejector plate 41 from the core carrier frame 11 is therefore possible with less work and time consumption. In particular, the disassembly of the structural unit comprised of a core part 31 and ejector plate 41 is no longer necessary. As such, a rapid and simple reconfiguring of the tool for the production of various molded parts each with an assigned core part 31 and an assigned ejector plate 41 is possible.

With regards to the jacket die 51, it should be noted that this typically has a simpler construction in comparison to the core part 31 without the actuating ejector plate. Nonetheless, it is possible that a jacket carrier frame together with a central passage for carrying an ejector plate is also designated for the jacket die 51, similar to the core carrier frame 11.

The FIGS. 12 and 13 depict in schematic sectional views, i.e. longitudinal section and transverse section, the basic parts of the aforementioned device such that one can abstain from further configurations in making reference to the reference symbols and the previous explanations.

It is noted that the invention and the advantages associated with it can also be used for a device for the production of injection molded parts or press-molded parts.

Finally, please note that the exemplary configuration previously described serves to elaborate the innovative features of the invention, but does not limit the invention to this exemplary configuration.

That which is claimed:

1. A device for the production of molded parts, comprising a core part, an ejection device operatively associated with the core part, a core carrier frame supporting the core part and the ejection device and a jacket die, wherein the core part and the jacket die are braced against each other such that they define a cavity corresponding to the molded part, wherein the core carrier is embodied as a core carrier frame which includes a passage, wherein the core part and the ejection device form a structural unit which can be inserted in the core carrier frame from one side thereof so that the ejection device extends through the passage when in an assembled state, and wherein the core carrier frame includes at least two opposing frame legs which serve to directly support the exterior of the core part and with the core part including lateral support members which rest against the core carrier frame when the device is in an assembled state.

2. The device of claim 1, wherein the core part extends at least in part into the passage of the core carrier frame when in the assembled state.

3. The device of claim 1, wherein the passage is embodied in an intermediate position in the core carrier frame.

4. The device of claim 1, wherein the passage is designed to be generally right-angled.

5. The device of claim 1, wherein the core carrier frame is designed to be essentially symmetrical.

6. The device of claim 1, wherein the frame legs of the core carrier frame are of an essentially right-angled cross section.

7. The device of claim 1, wherein the ejection device comprises an ejector plate connected with the core part, which can be driven relative to the core part for the ejection of the molded part produced.

8. The device of claim 7, wherein the ejector plate is connected with the core part via actuator rods and/or guide elements and that the core carrier frame surrounds the actuator rods and/or guide elements such that they freely extend through the passage.

9. The device of claim 8, wherein the structural unit comprised of the core part and the ejection device can be mounted onto the core carrier frame with the ejector plate extending through the core carrier frame.

10. The device of claim 1, wherein the core part extends at least in part form-fit into the passage of the core carrier frame when the device is in an assembled state.

11. The device of claim 1, wherein the core carrier frame is mounted on a base plate.

12. The device of claim 11, wherein the core carrier frame rests on a support post of the base plate so as to maintain a certain distance to said base plate.

13. The device pursuant to claim 12, wherein the support post features upright distance bodies positioned around the perimeter of the base plate and extending orthogonally from the base plate.

14. The device of claim 13, further comprising a liftable adapter plate supported between the base plate and the core carrier frame, which is effectively connected with the ejector plate in the assembled state.

15. The device of claim 14, wherein the adapter plate can essentially be moved above the height of the support post and against the core carrier frame.

16. The device of claim 15, wherein the movement of the adapter plate occurs via lifting devices functioning between the adapter plate and the core carrier frame.

17. The device of claim 16, wherein the lifting devices are allocated on the outside of the core carrier frame.

18. The device of claim 16, wherein a total of four lifting devices are allocated on long sides of the core carrier frame.

19. A device for the production of molded parts, comprising
a core carrier frame including laterally spaced apart frame legs which define a central passage therebetween,
a core assembly which includes a core part having an upwardly facing die surface, an ejector plate which is upwardly moveable with respect to the core part and the die surface, and lateral support members connected to the core part, the core assembly forming a structural unit which can be assembled onto the core carrier frame with the lateral support members supported upon the frame legs of the core carrier frame and with the ejector plate extending through the central passage of the core carrier frame, and
a jacket die configured to be assembled onto the core assembly so as to define a mold cavity corresponding to a molded or cast part between the upwardly facing die surface of the core assembly and the jacket die, and wherein upward movement of the ejector plate serves to eject a molded or cast part from the mold cavity.

20. The device of claim 19, further comprising a base plate which is mounted to the core carrier frame via upright support posts which define a determined distance, with the support posts being positioned in spaced arrangement about the perimeter of the rectangular core carrier frame.

21. The device of claim 20, further comprising an adapter plate supported below the ejector plate and above the base plate, and actuating means for lifting the adapter plate, so that lifting of the adapter plate lifts the ejector plate to remove a molded or cast part from the mold cavity.

22. A structural unit for a device for the production of molded parts, comprising
a core part and an ejection device assembled to the core part,
wherein the core part and the ejection device are carried by a core carrier and
wherein the core part and a jacket die are braced against one another, thus embodying a cavity corresponding to the molded part, wherein the core carrier is in the form of a core carrier frame with a passage and that the structural unit can be inserted from the one side into the core carrier frame and that the ejection device extends through the passage wherein in an assembled state.
